(19) United States
(12) Patent Application Publication
(10) Pub. No.: US 2024/0412962 A1
(43) Pub. Date: Dec. 12, 2024

(54) METHODS AND SYSTEMS FOR DETERMINING MOLECULAR MASS

(71) Applicant: DH Technologies Development Pte. Ltd., Singapore (SG)

(72) Inventors: Eva DUCHOSLAV, Toronto (CA); Yves LE BLANC, Newmarket (CA)

(73) Assignee: DH Technologies Development Pte. Ltd., Singapore (SG)

(21) Appl. No.: 18/689,495

(22) PCT Filed: Sep. 9, 2022
(86) PCT No.: PCT/IB2022/058518

§ 371 Date: Mar. 6, 2024

Related U.S. Application Data
(60) Provisional application No. 63/242,220, filed on Sep. 9, 2021.

(51) Int. Cl. H01J 49/00

(52) U.S. Cl. CPC H01J 49/0031; H01J 49/0009; H01J 49/0036

(57) ABSTRACT

Methods and systems for adjusting instrument setting, improving fidelity of isotope pattern for mass spectra, and/or determining molecular mass with improved accuracy are disclosed. In one example, a method for determining Mₘₒₙₒ of a compound of interest in a sample using a mass spectrometer is provided. The method comprises: (1) tuning or adjusting instrument setting of the mass spectrometer using at least one known compound, wherein the instrument setting comprises at least one parameter for improving accuracy; (2) analyzing the compound of interest using the adjusted instrument setting to obtain a mass spectrum thereof, wherein the mass spectrum comprises an isotope pattern thereof; and determining the Mₘₒₙₒ of the compound of interest from the mass spectrum thereof.

### CROSS-REFERENCE TO RELATED APPLICATION

This application is being filed on Sep. 9, 2022, as a PCT International Patent Application that claims priority to and the benefit of U.S. Provisional Application No. 63/242,220, filed on Sep. 9, 2021, which application is hereby incorporated by reference in its entirety.

### INTRODUCTION

The monoisotopic mass of a complex biological molecule provides specific mass spectrometric information, which is useful for compound identification from the mass spectrum. Unfortunately, the abundance of the monoisotopic ions continually diminishes relative to the abundances of the major ions as the molecular mass increases. Theoretically, the monoisotopic peak is usually the lightest in the isotopic distribution of an ion species in mass spectrometry. However, due to interfering factors, monoisotopic peak identification/assignment in the mass spectrum of a high-mass compound is practically difficult.

In biomolecule qualitative applications, such as peptide and oligonucleotide impurity characterization, mass difference of two putative products, such as a parent molecule and an oxidative deamination thereof, is approximately 1 Da and thus requires accurate neutral monoisotopic mass determination. Assignment of correct neutral monoisotopic mass for larger molecules that have resolved peaks of isotope cluster across a linear dynamic range is challenging. Frequently, a part of the isotope cluster obtained from the mass spectrum is immersed in background noise and not ascertainable in good confidence. Also, due to the considerable widths, isotope clusters of different ions are also partially overlapped in the mass spectrum and not discernable.

Because the fidelity of the isotope patterns from a mass spectrum is critical in monoisotopic and average mass assignments for biomolecules, it is highly desirable for methods and systems to obtain mass spectra providing high-quality isotope patterns that are of high fidelity and/or not distorted. It is also desirable for methods to improve the accuracy for determination of monoisotopic mass based on mass spectrometry.

### SUMMARY

In one aspect, the present disclosure provides a method of adjusting/optimizing instrument setting of a mass spectrometer and/or improving fidelity of isotope patterns for analyzing a compound of interest. In some embodiments, the method comprises: (1) analyzing the known compound using the mass spectrometer to produce a mass spectrum thereof, wherein the known compound has a predetermined Mₘₒₙₒ, and wherein the mass spectrum comprises one or more m/z isotope pattern thereof; (2) obtaining an experimental Mₐᵥₑ of the known compound based on the m/z isotope pattern of the known compound and a given charge state z for each m/z isotope pattern; (3) tuning the at least one parameter of the mass spectrometer when analyzing the known compound and monitoring one or more m/z isotope patterns thereof in response to the parameter change; (4) determining an optimal level/range of the parameter under which the experimental Mₐᵥₑ for each charge state of the known compound correlate to a predetermined theoretical value; (5) recording/saving the adjusted instrument setting; and (6) analyzing the compound of interest using the adjusted instrument setting.

In some embodiments, the predetermined theoretical value of Mₐᵥₑ according to the present disclosure is determined according to the one or both of the following models or any equivalent thereof:

$${M}_{ave} = {M}_{mono} ⋆ ( 1 + Slope ) , \qquad ( I )$$

Mₐᵥₑ=Mₘₒₙₒ+M_{distance}, wherein Slope has a predetermined value and M_{distance}=Mₘₒₙₒ*Slope. (II)

In another aspect, the present disclosure provides a method for improving accuracy for determination of monoisotopic mass (Mₘₒₙₒ) of a compound of interest using a mass spectrometer, the method comprising: (1) adjusting instrument setting of the mass spectrometer using at least one known compound, wherein the instrument setting comprises at least one parameter; (2) analyzing the compound of interest using the adjusted instrument setting to obtain a mass spectrum thereof; and (3) determining the Mₘₒₙₒ of the compound of interest from the mass spectrum thereof. In some embodiments, the method further comprises: (1) obtaining an average mass (Mₐᵥₑ) of the compound of interest based on the isotope pattern thereof, wherein the isotope pattern consists of a plurality of isotopic peaks representing an isotope distribution of the ionized compound of interest; and (2) determining the monoisotopic mass of the compound of interest according to the following equation: Mₘₒₙₒ=Mₐᵥₑ/(1+Slope), wherein Slope has a predetermined value.

In yet another aspect, the present disclosure provides a method for determining monoisotopic mass (Mₘₒₙₒ) of a compound of interest in a sample using a mass spectrometer, the method comprising: (1) adjusting instrument setting of the mass spectrometer using at least one known compound, wherein the instrument setting comprises at least one parameter for improving accuracy; (2) analyzing the compound of interest using the adjusted instrument setting to obtain a mass spectrum thereof, wherein the mass spectrum comprises an isotope pattern thereof; and (3) determining the Mₘₒₙₒ of the compound of interest from the mass spectrum thereof. In some embodiments, the method further comprises: (1) obtaining an average mass (Mₐᵥₑ) of the compound of interest based on the isotope pattern thereof, wherein the isotope pattern consists of a plurality of isotopic peaks representing an isotope distribution of the ionized compound of interest; and (2) determining the monoisotopic mass of the compound of interest according to the following equation: Mₘₒₙₒ=Mₐᵥₑ/(1+Slope), wherein Slope has a predetermined value.

In some embodiments, the adjusting instrument setting further comprises: (1) analyzing the known compound using the mass spectrometer to produce a mass spectrum thereof, wherein the known compound has a predetermined Mₘₒₙₒ, and wherein the mass spectrum comprises one or more m/z isotope pattern thereof; (2) obtaining an experimental Mₐᵥₑ of the known compound based on the m/z isotope pattern of the known compound and a given charge state z for each m/z isotope pattern; (3) tuning the at least one parameter of the mass spectrometer when analyzing the known compound and monitoring one or more m/z isotope patterns thereof in response to the parameter change; (4) determining an optimal level/range of the parameter under which the experimental Mₐᵥₑ for each charge state of the known compound correlate to a predetermined theoretical value; and (5) recording/saving the adjusted instrument setting.

In some embodiments, the adjusting instrument setting of the mass spectrometer and/or improving fidelity of isotope pattern comprises: (a) analyzing a sample containing a mixture of known compounds, each known compound having a predetermined Mₘₒₙₒ, and wherein the mass spectrum comprises one or more m/z isotope pattern thereof related to each known compound; (b) obtaining an experimental Mₐᵥₑ of each known compound based on m/z isotope patterns related to each known compound and a given charge state z for each m/z isotope pattern; (c) tuning the at least one parameter of the mass spectrometer when analyzing the known compound and monitoring one or more m/z isotope patterns thereof in response to the parameter change; (d) determining an optimal level/range of the parameter under which the experimental Mₐᵥₑ for each charge state of each known compound correlate to a predetermined theoretical value with respect to each known compound; and (e) recording/saving the adjusted instrument setting.

In some embodiments, the predetermined Mₘₒₙₒ for the known compounds differ from each other and cover a mass range.

In a further aspect, the present disclosure relates to a method for establishing a linear relationship between Mₘₒₙₒ and Mₐᵥₑ for a class of biomacromolecules and/or for determining the value of Slope, the method comprising: (1) analyzing a plurality of standard compounds by using the mass spectrometer to obtain an experimental Mₐᵥₑ of each standard compound, wherein experimental values of the Mₐᵥₑ are distributed in an operational range, and wherein each of the standard compound has a theoretical Mₘₒₙₒ; (2) obtaining an experimental value of M_{distance} for each of the standard compound according to equation: M_{distance}=Mₐᵥₑ−Mₘₒₙₒ; (3) fitting the experimental values of the M_{distance} and the theoretical Mₘₒₙₒ using a linear model in the operational range to deduce the following equation or an equivalent thereof: Slope=M_{distance}/Mₘₒₙₒ; and (4) determining the value of Slope.

In some embodiments, the experimental Mₐᵥₑ of the known compound is calculated by averaging the peak mass of the isotopic peaks using a peak intensity cutoff of about 0.1, or about 0.2, or about 0.3, or about 0.4, or about 0.5.

In some embodiments, the compound of interest and the known compound are of the same class. In certain embodiments, the compound of interest and the known compound both belong to a class of biomacromolecule selected from group including a peptide, a protein, a nucleotide, a polycarbohydrate, or derivatives or metabolites thereof.

In some embodiments, the present method for determining Mₘₒₙₒ of a compound of interest further comprise obtaining an estimated range of molecular mass of the compound of interest prior to adjusting instrument setting.

In some embodiments, the known compound has a Mₘₒₙₒ that is in the estimated range of molecular mass (M) of the compound of interest.

In some embodiments, the estimated range is from about 100 Da to about 100 Da to about 100 kDa, or from about 500 Da to about 80 kDa, or from about 1 kDa to about 60 kDa, or from about 5 kDa to about 50 kDa, or from about 10 kDa to about 40) kDa, or of at least 100 Da, or at least 500 Da, or at least I kDa, or at least 5 kDa, or at least 10 kDa, or at least 20 kDa, or at least 40 kDa.

In some embodiments, the standard compound and the compound of interest are of the same chemical or biochemical class.

In another aspect, the present disclosure provides a system for determining monoisotopic mass (Mₘₒₙₒ) of a compound of interest in a sample, the system comprising: (1) a mass spectrometer comprising: (a) an ion generator configured to ionize a compound and produce an isotopic ion cluster thereof; and (b) an analyzer configured to analyze the ion cluster and obtain m, z, and m/z of the ion cluster; and (2) a computer system in communication with the mass spectrometer, wherein the computer system is configured to: tune in response to a user instruction, at least one parameter of the mass spectrometer; instruct the mass spectrometer to analyze the compound of interest under a filtering instrument setting determined by at least one known compound; receive the series of signal for series of m/z of the ion clusters and produce a mass spectrum of the compound of interest; calculate a Mₐᵥₑ for each charge series of the compound based on the mass spectrum thereof; and determine the Mₘₒₙₒ for each individual charge state of the compound of interest according the following equation: Mₘₒₙₒ=Mₐᵥₑ/(1+Slope), wherein Slope has a predetermined value.

In some embodiments, the present system is further configured to: (a) analyze the known compound to produce a mass spectrum thereof, wherein the known compound has a predetermined Mₘₒₙₒ, and wherein the mass spectrum comprises at least one isotope pattern thereof; (b) obtain an experimental Mₐᵥₑ of the known compound based on the isotope pattern of the known compound; (c) tune the at least one parameter of the mass spectrometer when analyzing the known compound and monitoring the isotope pattern thereof in response to the parameter change; (d) determine an optimal level/range of the parameter under which the experimental Mₐᵥₑ of the known compound correlates to the predetermined Mₘₒₙₒ according to the following equations of any equivalent thereof: Mₘₒₙₒ=Mₐᵥₑ/(1+Slope), Mₘₒₙₒ=Mₐᵥₑ−M_{distance}, wherein Slope has a predetermined value and M_{distance}=Mₘₒₙₒ*Slope; (e) record/save the adjusted instrument setting; (f) consolidate the results from each individual charge state into Mₘₒₙₒ for the compound of interest.

In yet another aspect, the present disclosure provides a computer-readable medium containing computer instructions stored therein, wherein computer-readable medium is configured to cause a computer to perform a method for determining Mₘₒₙₒ of a compound of interest, the method comprising: (1) instructing a mass spectrometer in communication with the computer to analyze the compound of interest using an adjusted instrument setting to obtain a mass spectrum thereof; obtaining Mₐᵥₑ of the compound of interest from the mass spectrum thereof; and determining the Mₘₒₙₒ of the compound of interest according to the following equation: Mₘₒₙₒ=Mₐᵥₑ/(1+Slope), wherein Slope has a predetermined value, wherein, the adjusted instrument setting is determined by at least one known compound.

The details of one or more techniques are set forth in the accompanying drawings and the description below. Other features, objects, and advantages of these techniques will be apparent from the description, drawings, and claims.

### BRIEF DESCRIPTION OF THE DRAWINGS

FIG. 1 is a schematic diagram of one example system for determining molecular mass of a sample, according to the present disclosure.

FIG. 2 is a schematic diagram of one particular example system of FIG. 1, in accordance with various embodiments of the present disclosure.

FIG. 3 is a schematic diagram of one example computer system of FIGS. 1-2, in accordance with various embodiments of the present disclosure.

FIG. 4 illustrates one example of the mass spectrum 250 of FIG. 2, in accordance with various embodiments of the present disclosure.

FIG. 5 illustrates one example of isotope cluster (pattern) of the mass spectrum 250 of FIG. 2, in accordance with various embodiments of the present disclosure.

FIGS. 6A-6B illustrate one example of the linear relationship between the average mass (Mₐᵥₑ) and the monoisotopic mass (Mₘₒₙₒ) of biomolecules, according to the present disclosure.

FIG. 7 illustrates a block diagram of one example of the method 500, according to the various embodiments of the present disclosure.

FIG. 8 illustrates a block diagram of one example of the operation 510 of FIG. 7, according to the various embodiments of the present disclosure.

FIG. 9 illustrates an example dependency plot of M_{distance} as a function of the isotopic peak intensity cutoff.

FIG. 10 illustrates one example of the operation 530 according to FIG. 7.

FIG. 11 illustrates a block diagram of one example method for determining the relationship among Mₘₒₙₒ, Mₐᵥₑ, M_{distance}, and Slope for a class of molecules.

FIG. 12 illustrates one example diagram of the real time experimental M_{distance} against the predetermined M_{distance} or target M_{distance} during tuning of a parameter using a known compound, in accordance with Example 1.

FIG. 13 illustrates one example of data fitting to establish a linear relationship between the M_{distance} and the Mₘₒₙₒ for the family of BSA peptides, in accordance with Example 2.

FIG. 14 illustrates one example of data fitting to establish a linear relationship between the M_{distance} and the Mₘₒₙₒ for the family oligonucleotide having phosphorothioated locked nucleic acids and one unmodified DNA sequence, in accordance with Example 2.

FIG. 15 illustrates the post-analysis results for 40 dT oligomer and the assignment of monoisotopic mass (Mₘₒₙₒ) to the isotopic peaks, in accordance with Example 3.

FIG. 16 illustrates an example mass analysis of a 17.18 kDa compound subjected to hydrogen deuterium exchange, in accordance with Example 4.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It will be appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of ±20% or less, preferably ±10% or less, more preferably ±5% or less, and still more preferably #1% or less of and from the specified value, insofar such variations are appropriate to perform in the present disclosure. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

All references cited in the present specification are hereby incorporated by reference in their entirety. In particular, the teachings of all references herein specifically referred to are incorporated by reference.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

As used herein, an “isotope cluster” or “isotope pattern” or “m/z isotope pattern” refers to a grouping of intensity peaks associated with a single compound or a ionized species, where the compound or the ionized species that forms the isotope cluster can be isotopically enriched. The isotope cluster can include a single main peak (or main isotope peak) and two or more side peaks. The side peaks are generally of lower intensity than the main isotope peak, and can be both down-mass and up-mass of the main isotope peak. Although the separation between the main peak and side peaks can be measured in whole numbers, for example, 1, 2, 3, etc. Daltons 20 (“Da”), the separation may also be measured as non-whole numbers, for example, 0.5, 1.2, etc. For example, an isotope cluster with a main peak at “X” Da can include the intensity contribution of an up-mass side peak at “X+1” Da and the intensity contribution of a down-mass side peak at “X−1” Da.

As used herein, “intensity” refers to the height of, or area under, a MS peak. For example, the peak can be output data from a measurement occurring in a mass spectrometer (e.g., as a mass to charge ratio (m/z)). The charge “z” represents a charge state of the isotope cluster. The value of the charge state can be any positive or negative integer, such as +1, +2, +3, or −1, −2, or −3. In accordance with some embodiments of the present disclosure, intensity information can be presented as a maximum height of the summary peak or a maximum area under the summary peak representing a m/z value.

As used herein, the term “monoisotopic mass” or “Mₘₒₙₒ” means the sum of the masses of the atoms in a molecule using the mass of the principal (most abundant) isotope for each element instead of the isotopic average mass. For typical biomolecules, like proteins, peptides, polynucleotides, oligonucleotides, or polysaccharides, the monoisotopic mass results in the lightest isotope being selected. For a known compound with an ascertained chemical formula, the Mₘₒₙₒ can be theoretically pre-determined (M_{mono/theo}) based on the elemental composition thereof. Monoisotopic mass is typically expressed in Daltons (Da) or unified atomic mass units (u).

As used herein, the term “average mass” or “M_{average}” or “Mₐᵥₑ” corresponds to the sum of the masses of the atoms in a molecule using the isotopic average mass for each element. The “experimentally determined average mass” or “experimental average mass” or “experimental Mₐᵥₑ” refers to the average mass calculated as a weighted sum of the observed masses and intensities of the isotopic peaks from the mass spectrum of a molecule.

As used herein, the term “M_{distance}” represents the mass difference between the “Mₘₒₙₒ” and “Mₐᵥₑ” for a given molecule. For biomolecules such as proteins, peptides, polynucleotides, oligonucleotides, or polysaccharides, the monoisotopic mass of a molecule is typically less than the average mass of the same molecule, and the “M_{distance}” is obtained from the following equation: M_{distance}=Mₐᵥₑ−Mₘₒₙₒ. The M_{distance} can be experimental or theoretical. A theoretical M_{distance} is deduced from predetermined Mₐᵥₑ and Mₘₒₙₒ, e.g., from a compound library or database. An experimental M_{distance} may be obtained by analyzing a known compound or standard analyte with a predetermined theoretical Mₘₒₙₒ, according to the equation: M_{distance/expr}=M_{ave/expr}−M_{mono/theo}.

As used herein, the term “accuracy” or “mass accuracy” relates to the difference between the expected or theoretical “M_{theoretical}” or “Mₜₕₑₒ” (in Dalton) and the observed or experimentally determined “Mₑₓₚₑᵣᵢₘₑₙₜₐₗ” or “Mₑₓₚᵣ” (in Dalton) according to the formula: Accuracy=(|Mₜₕₑₒ−Mₑₓₚᵣ|)/Mₑₓₚᵣ*10⁶. Accuracy is expressed in ppm.

### System Comprising Mass Spectrometry System and Computer System

In the following passages, different aspects of the present disclosure are defined in more detail. Each aspect so defined may be combined with any other aspect or aspects unless clearly indicated to the contrary.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure, and form different embodiments, as would be understood by those in the art. For example, in the appended claims, any of the claimed embodiments can be used in any combination.

In the present disclosure, reference is made to the accompanying drawings that form a part hereof, and in which are shown by way of illustration only of specific embodiments in which the present disclosure may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

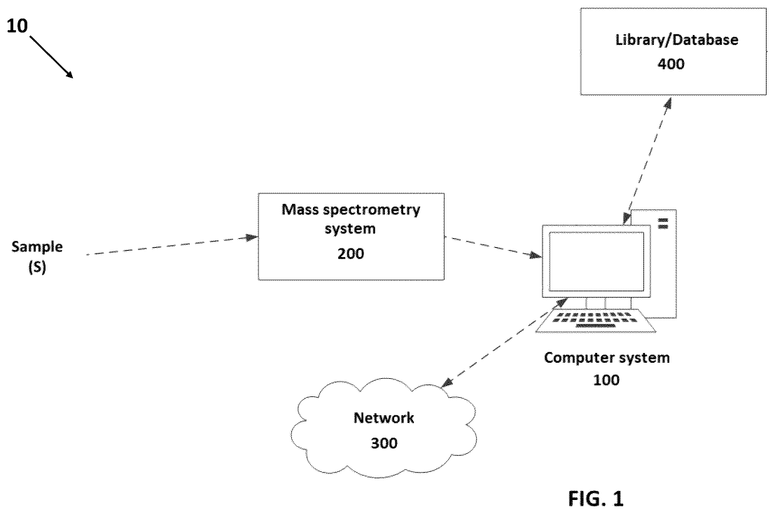

FIG. 1 illustrates an example system 10, upon which embodiments of the present teachings may be implemented. The system 10 is generally used for analytical purposes, including but not limited to: identifying analytes of the sample, processing mass spectrometry data, determining the molecular mass of one or more analytes in the sample, determining and/or predicting analyte identity, optimizing parameters/conditions for mass spectrometer operation, sample analysis, and data processing, or any combinations thereof.

The system 10 includes a computer system or device 100 and a mass spectrometry system 200. The computer system or device 100 is configured to perform various functions including but not limited to: receiving and responding to a user instruction, executing a user instruction, receiving and transmitting signal to the mass spectrometry system 200, monitoring operating parameters or testing conditions of the mass spectrometry system 200, modifying operation parameters in response to a user instruction, processing mass spectrometry data, generating and/or analyzing mass spectra, operating various computation functions including calculation of neutral mass, monoisotopic mass, average mass, most abundant mass, mass difference and shifts, determining charge states of the analyte, performing database or library search, and outputting/displaying data analysis results.

The mass spectrometry system 200 may be operably connected to the computer system 100. The mass spectrometry system 200 is configured to receive a sample(S) that is introduced thereto, produce ions, analyze the ions, generate mass spectrometry data including m/z and intensity associated with the ions, store the generated signal/data on a computer-readable medium, and/or transmit the signal/data to the computing device. The mass spectrometry system 200 is further configured to receive, upon user instruction, input from the computer system 100.

The sample(s) may be an isolated or purified compound comprising an analyte, or alternatively, a plurality of analytes. The analyte may consist of a standard compound with known formula or identity, a known compound with high purity. The sample may consist of a mixture of standard compounds or known compounds of the similar chemical or biochemical class. Alternatively, the sample may comprise one or more compound of interest. The compound of interest may be unknown or unidentified.

The sample may contain small molecules, biomolecules, macromolecules, biomacromolecules, and/or derivatives, degenerates, metabolites thereof. Examples of the sample include but are not limited to amino acids, carbohydrates, fatty acids, nucleotides, proteins, peptides, polynucleotides, lipids, polysaccharides. In one example, the sample is a specific metabolic product comprising metabolomics. The ions of the sample produced by the mass spectrometry system 200 may comprise ions in positive mode or negative mode. Non-limiting examples of positive ion mode include [M+H], [M+NH₄], [M+H+H], [M+Na], [M+K], [M+H+Na], [M+H+K], [M+M+H], [M+M+Na], [M+M+K]. Non-limiting examples of negative ion mode include [M−H], [M−H−H], [M−H−H+Na], [M−H−H+K], [M+M−H], [M+M−H−H+Na], [M+M−H−H+K], [M+Cl], [M+F], [M+HCOO], [M+NO₃].

In some embodiment, the mass spectrometry system 200 is in electrical or wireless communication with the computer system 100, and the computer system 100 is configured to receive directly, either automatically or upon user instructions, mass spectrometry data generated by and transmitted from the mass spectrometry system 100. In another embodiments, the mass spectrometry data is stored on a computer-readable medium, and the computer system 100 is configured to read the medium and retrieve the mass spectrometry data therefrom.

In one embodiment, the system further comprises a network 300. The network 300 may be operably connected to any one or all of the components in the system 10. The network 300 is a communication network. In the exemplary embodiment, the network 300 is a wireless local area network (WLAN). The network 300 may be any suitable type of network and/or a combination of networks. The network 300 may be wired or wireless and of any communication protocol. The network 300 may include, without limitation, the Internet, a local area network (LAN), a wide area network (WAN), a wireless LAN (WLAN), a mesh network, a virtual private network (VPN), a cellular network, and/or any other network that allows system 300 to operate as described herein.

In one embodiment, the system 10 further comprises one or more library/database 400. The database 400 can be a commercial database, or a private database containing analytical information from previously analyzed samples, or a mixture of both. The library/database 400 comprises chemical knowledge of standard of known compounds stored therein, including but not limited to chemical formula or elemental composition, neutral mass, monoisotopic mass, or mass of internal fragments thereof. The computer system 100 is configured to perform a search using the library/database 400 and/or compare data produced by mass spectrometry and processed by the computer system 100 to the database 400 containing molecular mass information therein to facilitate data analysis and compound identification.

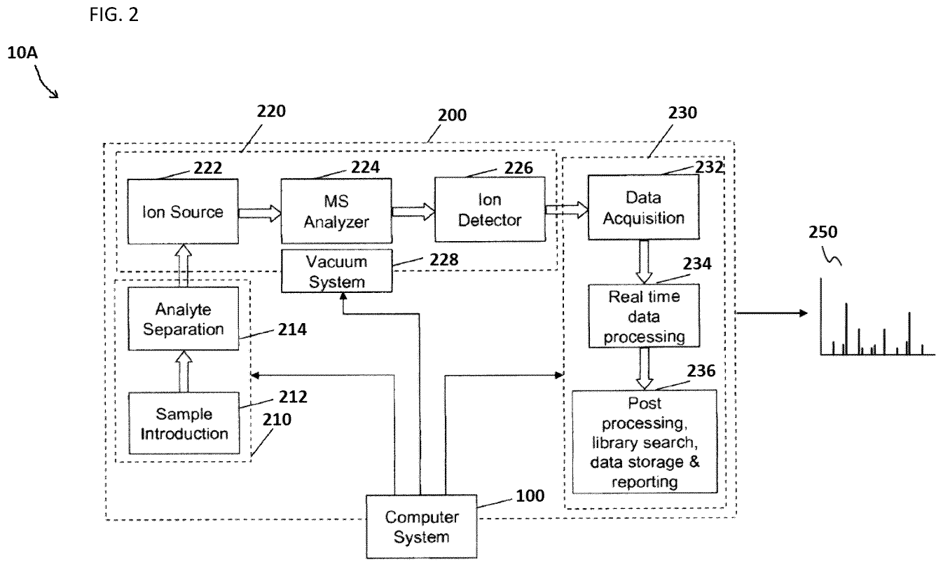

FIG. 2 is a block diagram that illustrates one particular embodiment 10A of the system 10. The system 10A includes a computer system 100 and a mass spectrometry system 200, upon which embodiments of the present teachings may be implemented.

The mass spectrometry system 200 is operably connected to the computer system 100. The mass spectrometry system 200 includes a sample introduction system 210, a mass spectrometer 220, and a data analysis system 230.

Sample introduction system 210 introduces a sample that includes one or more compounds of interest to the system 10A over time. The sample introduction system 210 includes a sample introduction unit 212, and optionally an analyte separation unit 214, which is used to perform a preliminary separation of analytes, such as proteins or oligonucleotides to be analyzed by system 10A. The analyte separation unit 214 can perform techniques that include, but are not limited to, ion mobility, gas chromatography (GC), liquid chromatography (LC), capillary electrophoresis (CE), or flow injection analysis (FIA).

The mass spectrometer 220 may include an ion source 222, a mass analyzer 224 for separating ions generated by ion source 222 by mass to charge (m/z) ratio, an ion detector 226 for detecting the ions from mass analyzer 224, and optionally a vacuum system 228 for maintaining a sufficient vacuum for mass spectrometer 220 to operate efficiently. If mass spectrometer 220 is an ion mobility spectrometer, generally no vacuum system is needed and the data generated are typically called a plasma gram instead of a mass spectrum.

Ion source 222 of the system 10A ionizes the sample to transform the sample into an ion beam. Ion source device 220 can perform ionization techniques that include, but are not limited to, matrix assisted laser desorption/ionization (MALDI) or electrospray ionization (ESI).

The mass spectrometer 220 can be any mass spectrometer that has the capability of measuring analyte masses with high resolution. Examples of the mass spectrometer include but are not limited to time-of-flight mass spectrometry (TOF), matrix-assisted laser desorption ionization time-of-flight mass spectrometry (MALDI-TOF), and any tandem MS such as QTOF, TOFTOF, etc. The mass spectrometer 220 can include separate mass spectrometry stages or steps in space or time, respectively. In some embodiment, the mass spectrometer 220 further comprises a detector and a mass analyzer.

The data analysis system 230 includes a data acquisition portion 232, which may include one or a series of analog to digital converters (not shown) or processors for converting signals from ion detector 226 into digital data. This digital data is provided to a real time data processing portion 234, which process the digital data through operations such as summing and/or averaging. A post processing portion 236 may be used to do additional processing of the data from real time data processing portion 234, including library searches, data storage, and/or data reporting.

The processors for the data analysis system 230 may be, but is not limited to, a computer, a processor, the computer system 100, or any device capable of sending and receiving control signals and mass spectrometry data from the mass spectrometer 230 and processing data. The data analysis system 230 may be in operably connected to any components of the mass spectrometry system 200, such as the sample introduction system 210, the mass spectrometer 220, or the data analysis system 230.

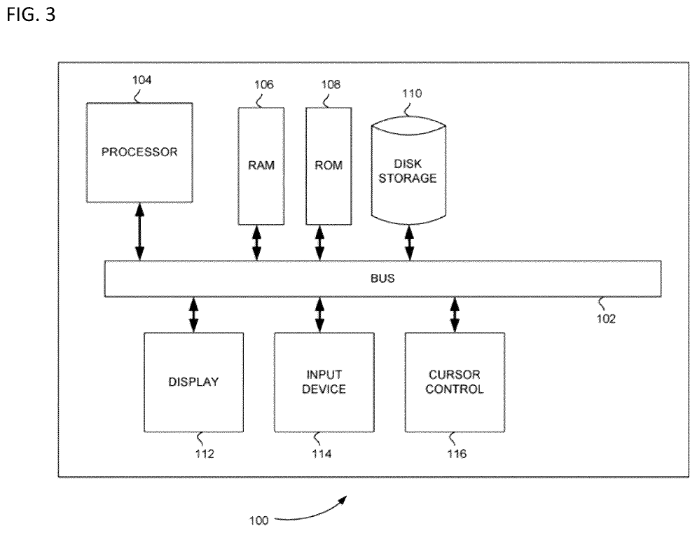

FIG. 3 illustrates a block diagram of one exemplary example of the computer system 100 of FIG. 2. the computer system 100 may provide control of the sample introduction system 210, the mass spectrometer 220, and the data analysis system 230. The computer system 100 generally includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

The computer system 100 can perform the present teachings. Consistent with certain implementations of the present teachings, results are provided by the computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process 10 described herein. Alternatively hard-wired circuitry may be used in place of or in combination with software instructions to implement the present teachings. Thus implementations of the present teachings are not limited to any specific combination of hardware circuitry and software.

In various embodiments, the computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The system 10A may produce mass spectrometry data for the sample analyzed by the system 10A. In some embodiments, the mass spectrometry data includes one or more mass spectra 250 for the sample analyzed by the system 10A. The mass spectrometry data may further include a compound information file which includes related information such as date and lot number of experiment, sample information, instrument parameters, test conditions, and so on. The mass spectrum 250) may be obtained from a high-performance or high-resolution mass spectrometer.

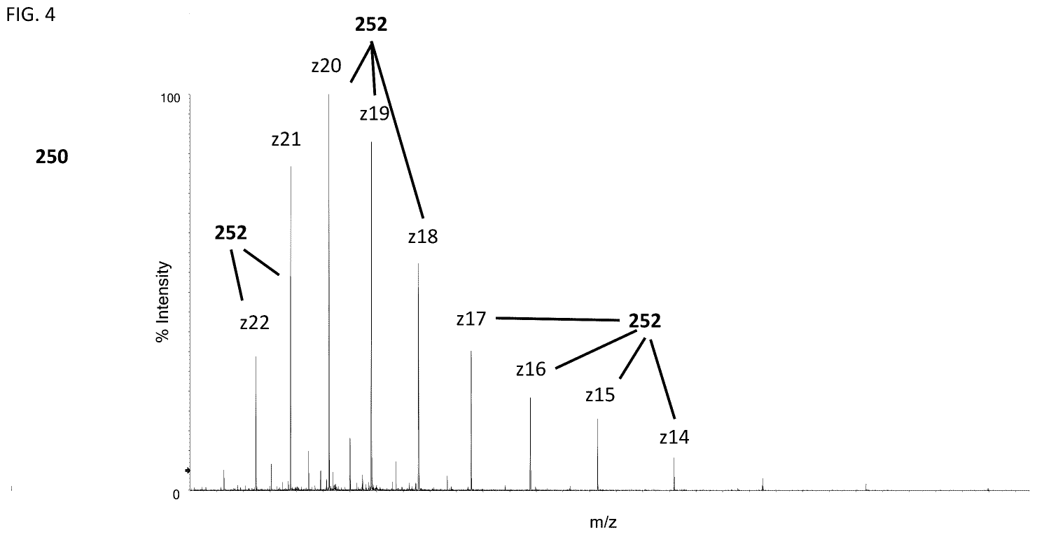

FIG. 4 is a schematic view of one example of the mass spectrum 250 of FIG. 2. In the illustrated example, the mass spectrum 250 includes at least one isotope pattern 252 associated with an isotopic ionized species produced by the ion source 222 of the mass spectrometer 220. The isotopic ionized species may have a series of charge states, e.g., z14 to z22 as shown in FIG. 4. The number of charge state may vary depending on many factors such as the chemical nature of the sample, ionization condition, coupling to separation technique (like differential mobility), and detection limit. In some embodiments, at least one isotope cluster is a ionized species of the compound that is associated with one particular charge state, and the neutral molecular mass (neutral mass) of the compound can be deduced from the mass-to-charge (m/z) value of the related ionized species obtained from the mass spectrum 250.

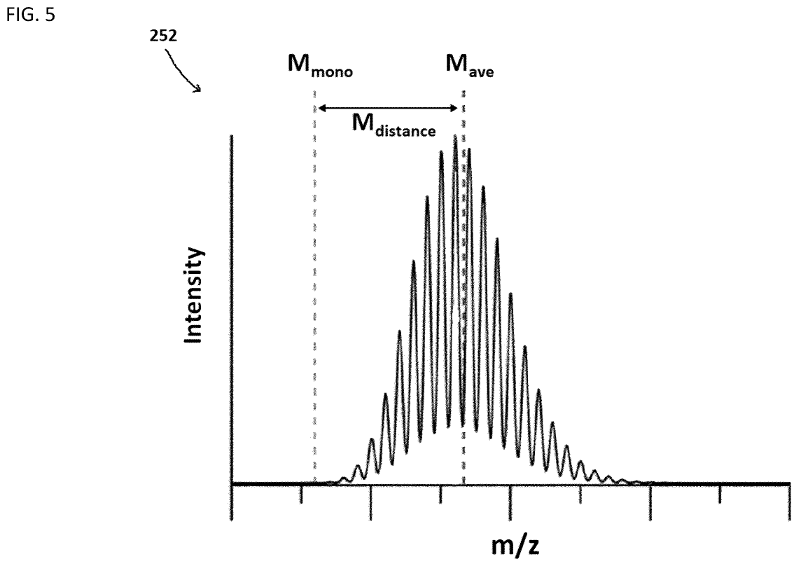

FIG. 5 illustrates an example of isotope cluster 252 of the mass spectrum 250. In the illustrated example, the isotope cluster represents an isotope distribution (or isotope pattern) of a ionized species of a compound. As can be seen, the monoisotopic mass (Mₘₒₙₒ) and the average mass (Mₐᵥₑ) are notably different. The distance (M_{distance}) is measured as the difference between the monoisotopic mass and the average mass.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Methods and Systems for Determining Monoisotopic Mass (Mₘₒₙₒ)

The present disclosure relates generally to improved methods and systems for the analysis or interpretation of spectra obtained by mass spectrometry, in particular of spectra of macromolecules or biomacromolecules comprising a plurality of isotope patterns, each isotope pattern comprising a plurality of isotopic peaks, i.e., a series of regularly spaced peaks representing the isotopic distribution of the biomacromolecule.

The elements occurring in most biomolecules, including the twenty proteinogenic amino acids, i.e. carbon, hydrogen, oxygen, nitrogen, and sulfur, all possess stable isotopes, the most abundant of which is referred to as the monoisotopic variant. The relative amounts of these isotopes are known and relatively constant for terrestrial matter. With the exception of sulfur, which is composed of approximately 94.9% ³²S and 5.1% heavier isotopes, the other four elements are composed for at least 98.9% of their lightest variant. As a consequence of the occurrence of multiple isotopes, an ion is visualized by mass spectrometry as a series of locally correlated peaks, termed the isotope distribution. There is a direct relation between the molecular formula of the ion and the shape/pattern of the isotope distribution.

For small molecules, such as metabolites, single amino acids or small peptides, single nucleic acids or small oligonucleotides, the monoisotopic variant (i.e. the variant in which all elements occur in their monoisotopic form) is the most abundant one. While relative abundance of isotopes, and thus the average mass of an element, may vary, monoisotopic masses are a constant of nature, unambiguous and invariant, and therefore an optimal choice for analyte identification and other data processing, e.g. database searching. However, direct measurement of the monoisotopic mass of macromolecules, such as proteins, is in many instances not feasible in practice. Indeed, for intact proteins, made up of thousands of atoms, the probability of encountering the monoisotopic variant actually becomes vanishingly small and this variant will therefore often fall below the limit of detection of contemporary mass spectrometers.

In practice, the average mass is quite sensitive to fluctuations in relative isotope abundances, which largely depends on the instrument setting of the mass spectrometer. Thus, it is important to optimize the instrument setting of the mass spectrometer in order to obtain high fidelity of the isotope pattern of mass spectra and distribution and/or calculate the average mass and/or monoisotopic mass from the high-fidelity isotope patterns in high accuracy. Determining the monoisotopic mass (Mₘₒₙₒ) of a macromolecule with improved accuracy is primordial to permit a reliable identification of the biomolecule.

The present disclosure provides a solution to improving accuracy for determination of monoisotopic mass (Mₘₒₙₒ) of molecules, particularly biomacromolecules of based on a series of isotopic peaks within a MS spectrum, with an accuracy in the low ppm range. In particular, the present disclosure is based, at least in part, on the approximately straightforward relationship between the average and the monoisotopic masses of biomolecules, which allows one to calculate the monoisotopic mass from a known average mass with a 0.1 Da order of precision and at least a 100 ppm order of accuracy.

The approximately linear or straightforward relationship between the average and the monoisotopic masses for biomolecules can be deduced from an “averagine” approach (Senko et al., J. Am. Soc. Mass. Spectrum, 1995(6), 229-233). As an example, an average amino acid was developed in modeling the isotopic distribution of peptide and proteins, using the statistical occurrences of the amino acids from a protein database. The averagine amino acid has the molecular formula C_{4.9384}H_{7.7583}N_{1.3577}O_{1.4773}S_{0.0417} and an average molecular mass of 111.1254 Da. As an example, the use of a uniform amino acid distribution for a model compound with an average molecular mass of about 20 kDa would produce a compound with a monoisotopic mass of 19986.44 Da, which is only deviated from the theoretical monoisotopic mass by about 41 ppm.

Various averagine models may be deduced from biomacromolecule compound database or alternatively established experimentally by using a series of standard analytes. More examples of the averagine model for specific proteins and nucleotides can be found in Zubarev et. al. (Rapid Communications in Mass Spectrometry, 1991(5), 276-277). For example, a linear model for peptide according to the equation: Mₘₒₙₒ=M_{average}−(M_{average}/1463) is pre-established and found to be highly accurate in calculating the Mₘₒₙₒ for various peptides, including Gramicidin S, Glucagon, Bovine insulin, Porcine proinsulin, Ribonuclease Sa, Hen egg-white lysozyme, and Human interleukin-2. As another example, a linear model was deduced from experimental data for oligonucleotides, represented by the equation: Mₘₒₙₒ=M_{average}−(M_{average}/2092).

It was surprisingly found that the “averagine” model could be utilized to efficiently and effectively optimize parameters of instrumental setting of a mass spectrometer and/or to accurately determine the Mₘₒₙₒ of an unknown compound of interest. The present solution uses the accuracy of the average neutral mass for the isotope cluster of the MS spectrum with respect to each charge state to find optimum instrument settings and/or test conditions for generation of uniform ion type as well as enhanced fidelity of isotope pattern across the acquired m/z range (or charge state range) for large biomolecules. The present solution significantly reduces the dimensionality of variables to control/optimize the instrument performance and/or to simplify feedback of the instrument suitability with respect to maintaining the isotope pattern fidelity.

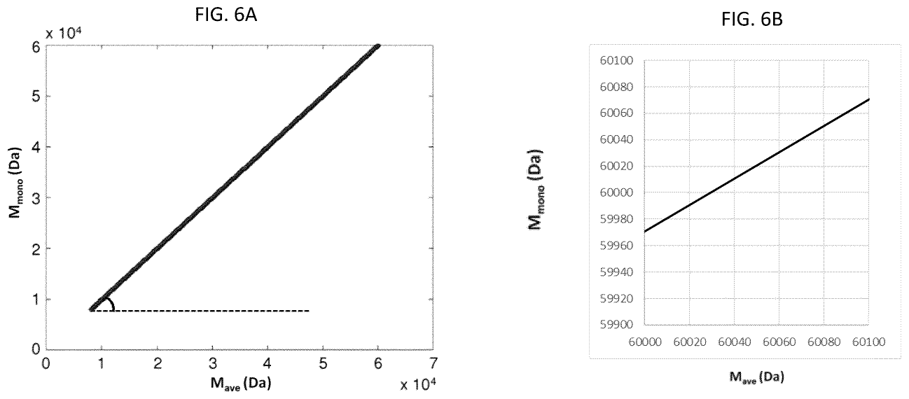

Now referring to FIGS. 6-11, exemplary examples of the present methods and operations thereof related to mass determination of a compound of interest will be illustrated and described. FIGS. 6A-6B illustrate one example of the linear relationship between the average mass (Mₐᵥₑ) and the monoisotopic mass (Mₘₒₙₒ) of biomolecules, according to the present disclosure. As can been seen, for molecular mass in a range of about 0 to about 10⁵ Da, the Mₐᵥₑ increases approximately linearly with increasing Mₘₒₙₒ, and the linear relationship has a slope (Mₘₒₙₒ/Mₐᵥₑ) that is about constant through the entire mass range. In some embodiments, the linear relationship between the Mₐᵥₑ and the Mₘₒₙₒ may be obtained from a priori information or experimental data using standard analyte with known or certain molecular mass. In some embodiments, a model or a mathematical equivalent thereof according to FIGS. 6A-6B is obtainable by fitting the slope of the plot of Mₘₒₙₒ in function of the Mₐᵥₑ for a plurality of known compounds with identified elemental composition, such as macromolecules from a macromolecule database. In some embodiments, generation of the averagine model, mathematical fitting, data processing, and/or calculation may be performed in silico.

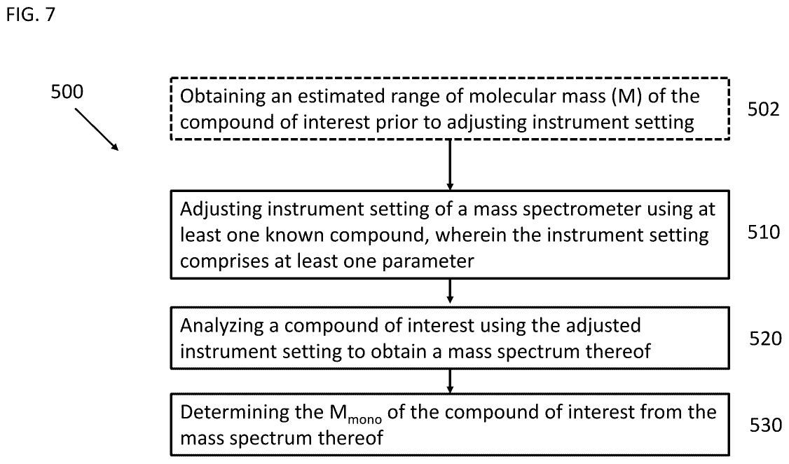

FIG. 7 illustrates a block diagram of one example of the present method 500. The method 500 may be executed by the system 10 or 10A, or any component thereof according to the present disclosure. The method 500 is generally used for determining the monoisotopic mass (Mₘₒₙₒ) of a compound of interest using a mass spectrometer. In some embodiments, the method 500 is used to improve accuracy for determination of Mₘₒₙₒ of a compound of interest. In some embodiments, the present method allows for improving the mass accuracy to a level of at least about 50 ppm, or about 40 ppm, or about 30 ppm, or about 20 ppm, or about 10 ppm.

Typically, the compound of interest is included in a sample prepared to be analyzed by the mass spectrometer. The compound of interest may be a small molecule, an oligomer, or a macromolecule. Macromolecules used herein refer to molecules of high molecular mass having a structure which essentially comprises of the multiple repetition of units derived from molecules (or subunits) of low molecular mass. In particular embodiments the macromolecule is a biomacromolecule. In particular embodiments, said biomacromolecule is a protein or polypeptide (made up of amino acids), a polynucleotide (DNA or RNA) (made up of nucleic acids), or a polysaccharide (made up of monosaccharides), or any derivatives or metabolites thereof. In the context of the present disclosure, the term “poly” as in polypeptide, polynucleotide, or polysaccharide corresponding to at least 10 subunits. Thus a polypeptide, polynucleotide, or polysaccharide comprises at least 10 amino acid residues, at least 10 nucleic acid residues, or at least 10 monosaccharides, respectively. In particularly preferred embodiments, the present disclosure is particularly suited for the determination of Mₘₒₙₒ of a protein and the subsequent identification and/or quantification of proteins, such as in top-down proteomics.

The term “macromolecule” within the scope of the present disclosure generally refers to molecules, in particular biomolecules, for example proteins but not limited thereto, with a mass substantially above 5 kDa, for example at least 10 kDa, at least at least 20 kDa, at least 30 kDa, or at least 40 kDa. Although the method of the present disclosure is particularly suitable for the identification of macromolecules with high molecular mass, it is also suitable for the identification of macromolecules with smaller molecular masses, for example a molecular mass of at least 100 Da, or at least 500 Da, or at least 1 kDa.

A person skilled in the art would appreciate that the methods and systems as described herein are not limited to particular mass spectrometers, and does as such not presuppose the use of high end, high resolution mass spectrometers. However, the teachings of the present disclosure are particularly suitable for analyzing a mass spectrum obtained from high-performance or high-resolution mass spectrometers such as times TOF Pro/flex (Bruker, MA), having accuracies in the order of 100 ppm. Advantageously, the present disclosure allows determination of Mₘₒₙₒ within at least 100 ppm, or at least 50 ppm, or at least 40 ppm, or at least 30 ppm, or at least 20 ppm, or at least 10 ppm, in line with the accuracy and precision of various high performance instruments.

The method 500 generally includes operations 510, 520, and 530. Operation 510 includes adjusting instrument setting of a mass spectrometer using at least one known compound, wherein the instrument setting comprises at least one parameter. Operation 520 includes analyzing the compound of interest using the filtering instrument setting to obtain a mass spectrum thereof. Operation 530 includes determining the Mₘₒₙₒ of the compound of interest from the mass spectrum thereof.

At operation 510, at least one known compound is used to adjust/optimize the instrument setting of the mass spectrometer that is to be used to analyze the compound of interest. In some embodiments, the compound of interest is of a known class, e.g., it is known to be a protein. Operation 510 may accordingly include selecting a known compound that is of the same or similar class or closely related to the compound of interest in kind. The known compound may be a standard or qualified analyte with a high purity. The known compound may have an identified or ascertained chemical formula/structure/elemental composition and/or a ascertained theoretical molecular mass (e.g., monoisotopic mass derived from the elemental composition of the known compound).

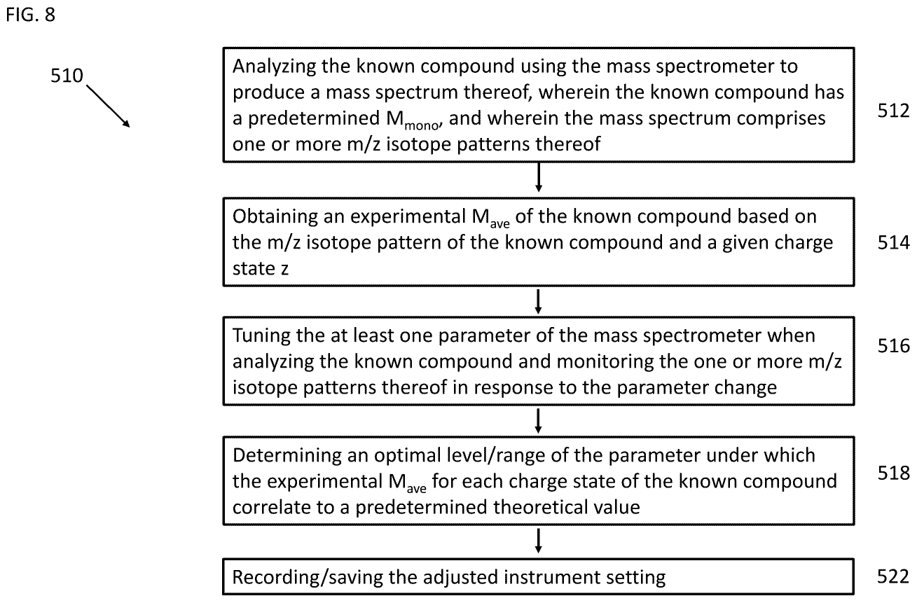

FIG. 8 illustrates a block diagram of one particular example of the operation 510. In the illustrated example, the operation 510 includes operations 512, 514, 516, 518, and 522. At operation 512, the known compound is analyzed using the mass spectrometer to produce a mass spectrum thereof. In particular, the known compound is ionized in the mass spectrometer to produce ionized species. The ion species produced in the ionization process may include molecular ions or fragmented ions in positive and negative modes derived from the neutral molecule of the known compound. The ions may carry different charge states. The ion species are identified and analyzed by the mass spectrometer to produce a mass spectrum that includes m/z isotope patterns derived from the ion species. In some embodiments, the known compound has a predetermined neutral Mₘₒₙₒ, and the mass spectrum of the known compound obtained from the mass spectrometer comprises one or more m/z isotope patterns related to the ionized species, with each isotope pattern representing a given charge state (z) and an isotopic distribution of MS peaks. In some embodiments, the mass spectrum of the known compound includes a plurality of m/z isotope patterns, wherein the charge state of the isotope pattern ranges from +1 to +100, or from −1 to −100, or from −100 to +100.

At operation 514, an experimental Mₐᵥₑ of the known compound is obtained based on the m/z isotope pattern of the known compound and the given charge state (z). For each isotope pattern, the experimental Mₐᵥₑ is deduced by calculating a weighted sum of the observed masses and intensities of the MS peaks of the isotope pattern from the mass spectrum of known compound, taking into account the z value of the charge state.

Operation 516 includes tuning the at least one parameter of the mass spectrometer when analyzing the known compound and monitoring the one or more m/z isotope patterns thereof in response to the parameter change. At operation 516, the known compound is analyzed by the mass spectrometer, which generates a real time mass spectrum of the known compound. The data analysis system or the computer system associated with the mass spectrometer may perform real time data processing that allows a user to monitor the isotope pattern and the calculated Mₐᵥₑ based on the isotope pattern, which can be visualized on a display unit. Tuning the at least one parameter of the instrument setting may be performed manually by a user or automatically by the computer system connected to the mass spectrometer executing a user instruction. Non-limiting examples of the parameter include XA1, bias voltage applied to channel electron multiplier (CEM), MS intensity cutoff, parameter controlling reaction region within the MS system.

Operation 518 includes determining an optimal level/range of the at least one parameter under which the experimental Mₐᵥₑ for each charge state of the known compound correlate to a predetermined theoretical value. At operation 518, the parameter of the instrument setting is tuned till the experimental Mₐᵥₑ derived from the isotope pattern for each charge state arrives at a satisfactory value that correlates to a predetermined value. Mₐᵥₑ is dependent, at least in part, on the shape or distribution modal of the MS peaks. On the other hand, Mₐᵥₑ also straightforwardly correlates to the Mₘₒₙₒ of the known compound. For example, as described previously, the relationship between Mₐᵥₑ and Mₘₒₙₒ for a given compound may satisfy the one or both of the following established mathematical models or any equivalent thereof:

Mₘₒₙₒ=Mₐᵥₑ/(1+Slope), wherein Slope has a predetermined value (I)

$${M}_{distance} = {M}_{ave} - {M}_{mono} , \qquad ( II )$$

$$wherein$$

$${M}_{distance} = Slope ⋆ {M}_{mono} .$$

Because the known compound has an identified chemical formula and an accurate Mₘₒₙₒ predetermined based on the elemental composition thereof, a theoretical Mₐᵥₑ of the known compound can be deduced from the equation (I) or (II). Thus, the real-time experimental Mₐᵥₑ provides a faithful measure for tuning/optimization of the instrument setting of the mass spectrometer. For example, the parameters of the instrument setting can be tuned to arrive at an optimal level/range at which the real-time experimental Mₐᵥₑ derived from the known compound that is analyzed by the mass spectrometer correlates to (or matches with or approximates) the theoretical Mₐᵥₑ of the known compound obtained from the established mathematical models (I) or (II). The optimized instrument setting can significantly improve the fidelity of the isotope pattern for the compound of interest, particularly when the compound of interest and the known compound are related to each other, or of the same chemical or biochemical class/genus, or of similar molecular mass.

In particular embodiments, the mass spectrum of the known compound includes a plurality of isotope patterns, each isotope pattern representing a given charge state (z), e.g., z1=+1, z2=+2, z3=+3, z4=+4, z5=+5, z6=+6, z7=+7, . . . as shown in FIG. 4. The parameters of the instrument are adjusted to arrive at an optimal level/range such that the experimental Mₐᵥₑ for each isotope pattern with respect to each charge stage correlates to or matches with or approximates the pre-determined theoretical Mₐᵥₑ that may be obtained from the established mathematical models (I) or (II). In some embodiments, the experimental Mₐᵥₑ and the theoretical Mₐᵥₑ with respect to each charge stage are closely matched with a difference therebetween less than about 0.2 Da, or about 0.1 Da, or about 0.01 Da, or about 0.001 Da under the optimal level/range of the instrument setting. In some embodiments, the parameters of the instrument setting are tuned till the mass difference between the experimental Mₐᵥₑ and the theoretical Mₐᵥₑ are closely matched for at least 50% of the charge states, or at least about 75% of the charge states, or at least 90% of the charge states, or at least about 99% of the charge states, or all detectable charge states for the ionized species, at which the instrument setting arrives at an optimal level/range.

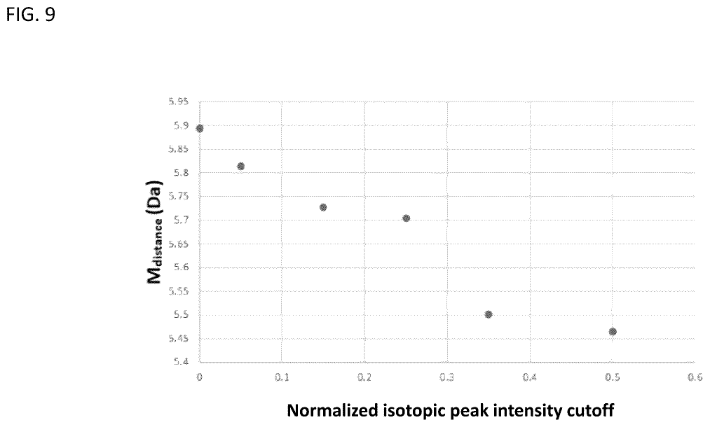

In some embodiments, the experimental Mₐᵥₑ of the known compound is calculated by averaging the peak mass of the isotopic MS peaks using a peak intensity cutoff of about 0.1, or about 0.2, or about 0.3, or about 0.4, or about 0.5. In some embodiments, the experimental data may not have signal in satisfactory quality for all MS peaks, and MS peaks above 10% of the base peak of isotope cluster are used. In addition, for the minor components of the sample smaller isotope peaks may be not detected or not distinguishable from background noise. For accurate mass determination, the calculated average mass may be affected by the isotopes (above intensity cutoff) considered. As the isotope distribution is typically not symmetrical, the calculated average mass may shift with eliminating low intensity isotope cluster peaks. This can be compensated for based on a dependency curve using just a subset of isotope peaks. FIG. 9 shows an example dependency plot of M_{distance} as a function of the isotopic peak intensity cutoff. In the illustrated example, the M_{distance} decreases as the isotopic peak intensity cutoff increases from 0 to 0.5 Da. The compensated M_{distance} derived from the dependency curve can be used to guide the operation of instrument setting optimization.

No referring back to FIG. 7, the method 500 may optionally include an operation 502. In some embodiments, the optional operation 502 includes obtaining an estimated range of molecular mass (M) of the compound of interest prior to adjusting instrument setting. At operation 502, the estimated range of the molecular mass of the compound of interest may be obtained from existing chemical information or prior knowledge, or from any analytical means that provides a fast and crude measurement for the molecular mass. In some embodiments, the method 500 may further include selecting one or more known compound(s) having a theoretical Mₘₒₙₒ that falls within the estimated range of the of the molecular mass of the compound of interest. As such, the fidelity of the instrument setting optimized by analyzing the known compound is maximized for analyzing the compound of interest that has similar molecular mass and/or chemical or biochemical class with the known compound.

In some embodiments, the estimated range of the compound of interest is from about 100 Da to about 100 kDa, or from about 500 Da to about 80 kDa, or from about 1 kDa to about 60 kDa, or from about 5 kDa to about 50 kDa, or from about 10 kDa to about 40 kDa, or of at least 100 Da, or at least 500 Da, or at least I kDa, or at least 5 kDa, or at least 10 kDa, or at least 20 kDa, or at least 40 kDa. Accordingly, in some embodiments, the method 500 has an operating mass range of determining the Mₘₒₙₒ of the compound of interest, the operating mass range is from about 100 Da to about 100 kDa, or from about 500 Da to about 80 kDa, or from about 1 kDa to about 60 kDa, or from about 5 kDa to about 50 kDa, or from about 10 kDa to about 40 kDa, or of at least 100 Da, or at least 500 Da, or at least I kDa, or at least 5 kDa, or at least 10 kDa, or at least 20 kDa, or at least 40 kDa.

In some embodiments, a sample containing a mixture of known compounds is used to adjust the instrument setting of the mass spectrometer to be used to analyze the compound of interest. The known compounds each have an identified elemental composition and a predetermined Mₘₒₙₒ that may fall within the estimated mass range of the compound of interest but are different from each other. The resulted mass spectrum of the mixture of known compounds accordingly include a mixture of isotope patterns derived from each known compound. The parameters of the instrument setting are adjusted/tuned to arrive at an optimal level/range at which the experimental Mₐᵥₑ and the theoretical Mₐᵥₑ are closely matched/fit with respect to each known compound. Optimizing the instrument settings using the mixture of known compounds may advantageously provide a broad operating mass window and/or further improve the fidelity of the isotope pattern for determination of the Mₘₒₙₒ for the compound of interest across the operating mass window.

At operation 520, the compound of interest is analyzed by introducing a sample containing the compound of interest to the mass spectrometer and analyzing the sample using the adjusted instrument setting to obtain a mass spectrum of the compound of interest. At operation 520, the mass spectrometry system generates a mass spectrum of the compound of interest. The mass spectrum includes at least one isotope cluster or isotope pattern of an ionized species derived from the compound of interest. Because the instrument setting has been optimized using the known compounds at operation 510, the isotope pattern of the compound of interest will have an improved fidelity, and the experimental Mₐᵥₑ derived from the isotope pattern will be close to the theoretical Mₐᵥₑ of the compound of interest. Therefore, the accuracy for determination of the mass of the compound of interest is improved.

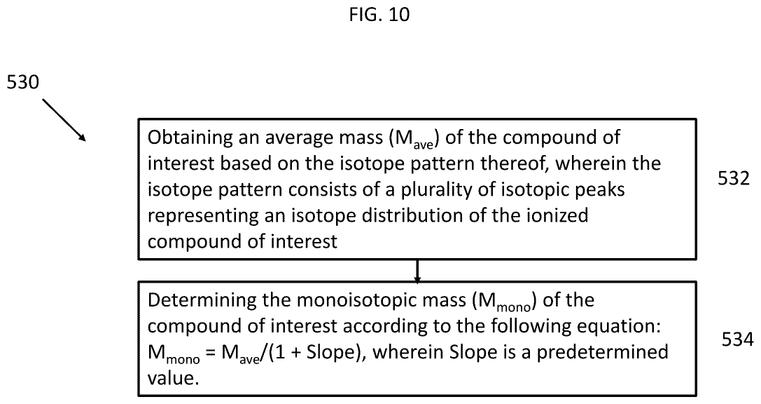

At operation 530, the Mₘₒₙₒ of the compound of interest is determined from the mass spectrum thereof. FIG. 10 illustrates one example of the operation 530. In the illustrated example, the operation 530 includes operations 532 and 534. Operation 532 includes obtaining an average mass (Mₐᵥₑ) of the compound of interest based on the isotope pattern thereof, wherein the isotope pattern includes of a plurality of isotopic peaks representing an isotope distribution of the ionized species related to the compound of interest. Operation 534 includes determining the monoisotopic mass (Mₘₒₙₒ) of the compound of interest according to the following equations:

Mₘₒₙₒ=Mₐᵥₑ/(1+Slope), wherein Slope has a predetermined value. (I)

In some embodiments, the mass spectrum of the compound of interest includes a plurality of isotope patterns, each isotope pattern corresponding to a given charge state, and the operation 530 accordingly includes consolidating the results calculated from each charge state into the Mₘₒₙₒ for the compound of interest. Weighing factors such as the fidelity of distribution for each isotope pattern, and m/z intensity cutoff, charge state selection, background noise removal may be taken into account in the process of consolidation and deduction of the final Mₘₒₙₒ value of the compound of interest.

In some embodiments, the sample contains a mixture of different compounds of interest, and the mass spectrum includes a plurality of isotope patterns representing more than one charge states with respect to each compound of interest. The operation 530 accordingly includes obtaining the Mₘₒₙₒ for each of the compounds of interest from the mass spectrum.

The value of Slope according to the present method or any operation thereof may be a predetermined value. As indicated above, the model or a mathematical equivalent thereof according to the equation (I) or (II) used in the present method is obtainable by fitting the slope of the plot of monoisotopic mass (Mₘₒₙₒ) in function of the average mass (Mₐᵥₑ) for a plurality of molecules, such as biomacromolecules from a biomacromolecule database. For obtaining the model according to equation (I) or (II), firstly, theoretical values for Mₘₒₙₒ and Mₐᵥₑ are derived for a plurality of molecules, such as from a biomacromolecule database, e.g., a protein database. The Mₘₒₙₒ of each biomacromolecule in the database corresponds to the sum of the masses of the atoms in the macromolecule using the mass of the principal (most abundant) isotope for each element instead of the isotopic average mass. For each biomacromolecule in the database, Mₐᵥₑ may be derived in silico from a simulated isotope distribution using suitable algorithms or software or existing models, such as the “averagine” approach reported in Senko et. al. and/or Zubarev et. al. described previously. Next, the monoisotopic mass Mₘₒₙₒ of each entry within the database is plotted against the most abundant mass Mₐᵥₑ, and an approximately linear relationship of Mₘₒₙₒ over Mₐᵥₑ with the value of Slope is obtained.

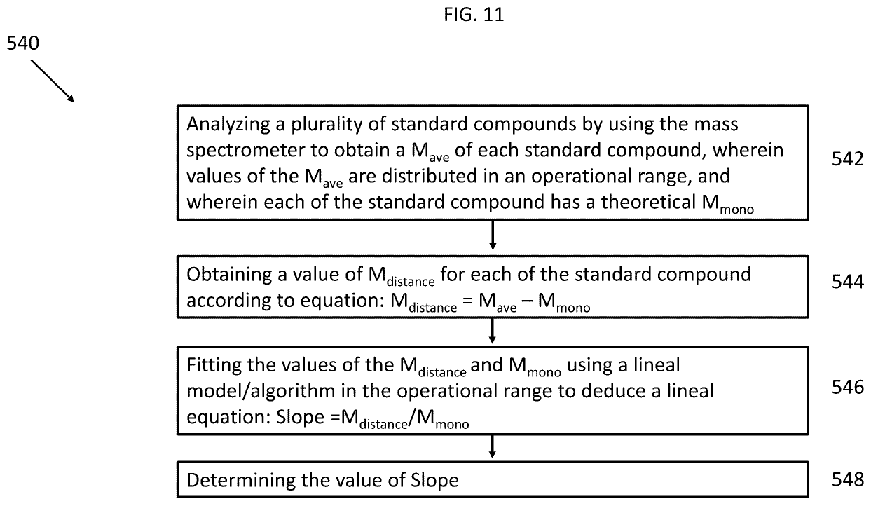

In some embodiments, the Slope is obtainable from mass spectrometry analysis of a plurality of standard compounds experimentally. FIG. 11 illustrates a block diagram of the method 540 for producing an operational model and/or deducing/calculating the Slope for the determination of Mₘₒₙₒ of the compound of interest, in accordance with the method 500 and various operations thereof. In the illustrated example, the method 540 includes operations 542, 544, 546, and 548. At operation 542, a plurality of standard compounds are analyzed by using the mass spectrometer to obtain a Mₐᵥₑ of each standard compound, wherein values of the Mₐᵥₑ are distributed in an operational mass range, and wherein each of the standard compound has a theoretical Mₘₒₙₒ. At operation 544, a value of M_{distance} is obtained for each of the standard compound according to equation: M_{distance}=Mₐᵥₑ−Mₘₒₙₒ. At operation 546, the values of the obtained M_{distance} and the Mₘₒₙₒ are subject to a fitting process using a linear regression model/algorithm in the operational range to deduce a linear equation: Slope=M_{distance}/Mₘₒₙₒ. At operation 548, the value of Slope is calculated and determined. The predetermined value of Slope can be used in the method 500 and any related operations thereof. In some embodiments, the value of Slope has a range from about 10⁻⁷ to about 1023, depending on the chemical class or nature of the biomacromolecule.

In some aspects, the present disclosure provides a method for determining monoisotopic mass (Mₘₒₙₒ) of a compound of interest using a mass spectrometer. The method is in consistency with the various aspects of the present teaching described previously. In one particular embodiment, the method comprises:

(1) adjusting/verifying instrument setting of the mass spectrometer by: (a) analyzing at least one known compound using the mass spectrometer to produce a mass spectrum thereof, wherein the known compound has a predetermined Mₘₒₙₒ, and wherein the mass spectrum comprises series of m/z isotope patterns thereof: (b) obtaining an experimental Mₐᵥₑ of the known compound based on the measured series of m/z isotope patterns of the known compound; (c) tuning the at least one parameter of the mass spectrometer when analyzing the known compound and monitoring the members of m/z isotope pattern series thereof in response to the parameter change; (d) determining an optimal level/range of the parameter under which the experimental Mₐᵥₑ of the known compound correlates at each charge state to the predetermined value of Mₘₒₙₒ; and (e) recording/saving the filtering instrument setting,

(2) analyzing the compound of interest using the filtering instrument setting to obtain a mass spectrum thereof, wherein the mass spectrum comprises an isotope pattern thereof;

(3) obtaining an average mass (Mₐᵥₑ) of the compound of interest based on the series of m/z isotope patterns thereof; and

(4) establishing an “averagine” function based on the elemental composition of the class or kind of the compound representative or a detailed information of the compound of interest according to the following mathematical model of equivalent thereof:

$${M}_{distance} = {M}_{ave} - {M}_{mono} , \qquad ( III )$$

$${M}_{distance} = Slope ⋆ {M}_{mono} ; \qquad ( IV )$$

and

(5) determining the Mₘₒₙₒ of the compound of interest according to the following equation: Mₘₒₙₒ=Mₐᵥₑ/(1+Slope).

The present method and various embodiments thereof can be implemented in a computer-readable medium described herein. The present method may be executed by the system or mass spectrometry system or the computer system thereof according to the disclosure. In one particular embodiment, a computer-readable medium containing computer instructions stored therein, wherein computer-readable medium is configured to cause a computer to perform a method for determining Mₘₒₙₒ of a compound of interest, the method comprising:

(1) instructing a mass spectrometer in communication with the computer to analyze the compound of interest using an adjusted instrument setting to obtain a mass spectrum thereof;

(2) obtaining Mₐᵥₑ of the compound of interest from the mass spectrum thereof; and

(3) determining the Mₘₒₙₒ of the compound of interest according to the following equation: Mₘₒₙₒ=Mₐᵥₑ/(1+Slope), wherein Slope has a predetermined value, wherein, the adjusted instrument setting is determined by at least one known compound.

In some aspects, the present disclosure provides a system for determining monoisotopic mass (Mₘₒₙₒ) of a compound of interest in a sample. The system is consistent with the various aspects of the present teaching described previously. In one particular embodiment, the system comprises:

(1) a mass spectrometer comprising an ion generator configured to ionize a compound and produce an isotopic ion cluster thereof; and an analyzer configured to analyze the ion cluster and obtain m, z, and m/z of the ion cluster;

(2) a computer system in communication with the mass spectrometer, wherein the computer system is configured to: (a) tune in response to a user instruction, at least one parameter of the mass spectrometer; (b) instruct the mass spectrometer to analyze the compound of interest under a filtering instrument setting determined by at least one known compound; (c) receive a series of ion clusters related to the compound of interest and produce a mass spectrum of the compound of interest, wherein the mass spectrum includes one or more isotope patterns, each representing an ion cluster with a given charge state (z) and having a plurality of MS peaks with detectable m/z values; (d) calculate a Mₐᵥₑ for each charge state of the ion cluster related to the compound of interest based on the mass spectrum thereof; (e) determine the Mₘₒₙₒ for each charge state of ion cluster related the compound of interest according the following equation: Mₘₒₙₒ=Mₐᵥₑ/(1+Slope), wherein Slope has a predetermined value; and (f) consolidate results from each individual charge state into an experimental Mₘₒₙₒ for the compound.

In some embodiments, the system is further configured to:
(1) analyze the known compound to produce a mass spectrum thereof, wherein the known compound has a predetermined Mₘₒₙₒ, and wherein the mass spectrum comprises an isotope pattern thereof;
(2) obtain an experimental Mₐᵥₑ of the known compound based on the isotope pattern of the known compound;
(3) tune the at least one parameter of the mass spectrometer when analyzing the known compound and monitoring the isotope pattern thereof in response to the parameter change;
(4) determine an optimal level/range of the parameter under which the experimental Mₐᵥₑ of the known compound correlates to the predetermined Mₘₒₙₒ according to the following mathematical models (I) or (II), or any equivalent thereof:

Mₘₒₙₒ=Mₐᵥₑ/(1+Slope), wherein Slope has a predetermined value (I)

Mₘₒₙₒ=Mₐᵥₑ−M_{distance}, wherein M_{distance}=Mₘₒₙₒ*Slope; and (II)
(5) record/save the optimized/adjusted instrument setting.

The present disclosure is further illustrated in the following examples.

### EXAMPLES

### Example 1—Optimization of Instrument Setting to Improve Isotope Cluster Fidelity

This example further illustrates the utilization of the accuracy of the average neutral mass for each charge state to find optimum instrument settings with respect to uniform ion type generation, to assure fidelity of isotope pattern for peptides, and to assure isotope pattern fidelity across the acquired m/z range (charge state range), using one or more known compound according to the underlying principles provided in the present disclosure.

The quality of isotope pattern fidelity can be monitored (such as within instrument suitability verification) in the collected data without a reference material (assuming peptide averagine composition and measuring the difference between monoisotopic and average masses for proteomics/therapeutic peptides) or specific large biomolecules.

Using the predetermined value of M_{distance} (the target distance of monoisotopic and average neutral masses), the instrument setting of the mass spectrometer is adjusted to an optimal level/range to assure fidelity of isotope pattern for large molecules—using the known compound. While tuning parameters to improve the isotope cluster fidelity, interfering ion type generation is minimized, and the instrument setting is optimized to achieve accurate average neutral mass for all detected charge states. The neutral mass corresponds to isotope peak intensity cutoff for each charge state.

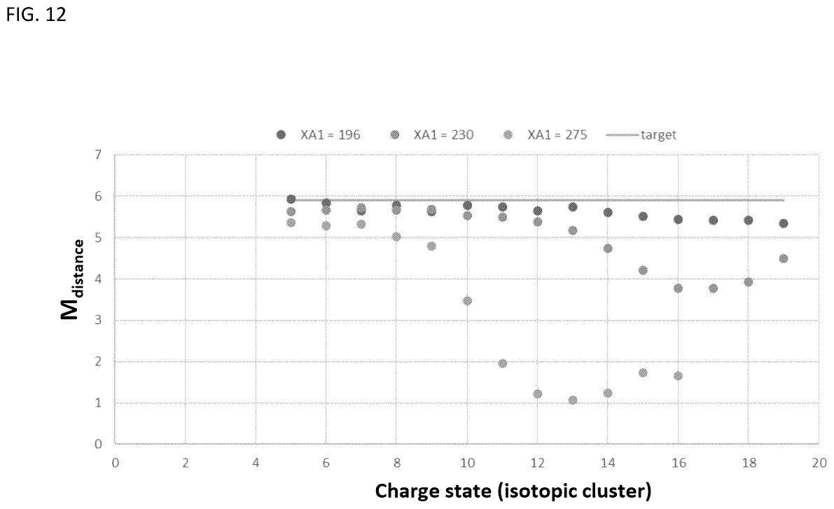

FIG. 12 illustrates an example diagram of the real time experimental M_{distance} against the predetermined M_{distance} or target M_{distance} during tuning of XA1 using a known compound under different values of XA1. The known compound in this example is 40T DNA, a polynucleotide with a chemical formula C₄₀₀H₅₂₁N₈₀O₂₇₈P₃₉, a predetermined Mₘₒₙₒ of 12099.99 Da, and a predetermined Mₐᵥₑ of 12105.779 Da. As can be seen, when the XA1 was adjusted to 275, the M_{distance} is not constant across the entire range of the charge states for the isotope clusters. Similarly, when the XA1 was adjusted to 230, the accuracy of the M_{distance} is improved for charge states 8-16 compared to the XA1 of 275. When the XA1 was further adjusted to 196, the experimental M_{distance} become approximately constant across the entire range of the charge states, i.e., from 5 to 19, indicating an optimal level of the XA1 and an optimal fidelity of all isotope clusters. In particular, better isotope pattern fidelity could be obtained at relatively lower charge states with the corresponding m/z in high value. From the data processing perspective, the limit of recoverable difference for monoisotopic mass determination is 0.5 Da. The optimized XA1 (196) value was recorded and used for analyzing a compound of interest that is of the same chemical or chemical class as the known compound. Though the example provided here was applied to tuning of XA1, other instrument parameters that may have impact on isotope distribution, such as CEM voltage/bias, could also benefit from this approach.

### Example 2—Determination of Monoisotopic Mass, Correction for Isotope Cluster Peak Shape, Determination of Mixture Isotope Clusters

Assuming a linear biomacromolecule, the relationship between M_{distance} (the distance of Mₘₒₙₒ and Mₐᵥₑ for a given neutral mass) and Mₘₒₙₒ can be determined using the “averagine” approach. From a molecular formula of an intact molecule, the Mₘₒₙₒ, Mₐᵥₑ, M_{distance}, and Slope could be determined and the linear relationship could be plotted according to the following mathematic model or an equivalent thereof:

Slope=(Mₐᵥₑ−Mₘₒₙₒ)/Mₘₒₙₒ, wherein Mₐᵥₑ−Mₘₒₙₒ=M_{distance}.

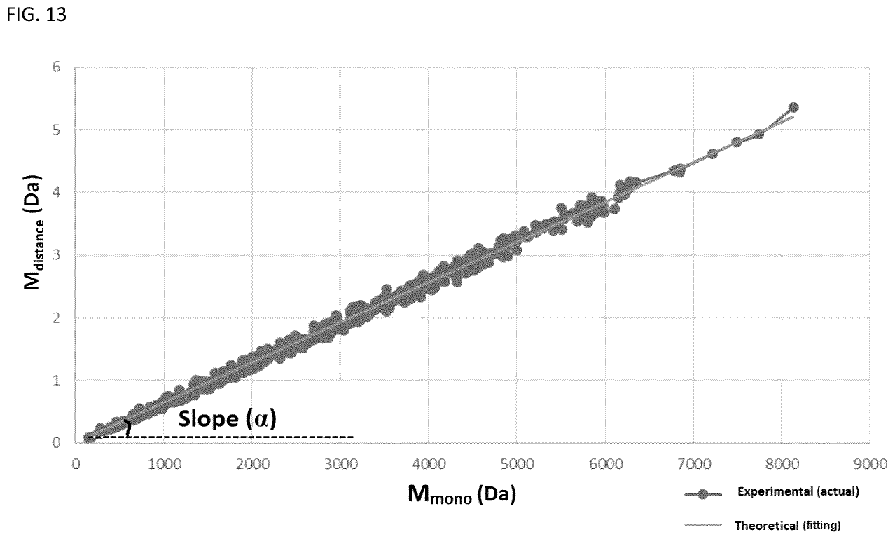

The validity of the assumption was verified with a number of 480 BSA peptides with various Mₘₒₙₒ across a broad operational range from about 100 Da to about 8,500 Da. As shown in FIG. 13, the M_{distance} and the Mₘₒₙₒ obtained from the mass spectrometry data are well fit by a linear model across the operational range, with Slope calculated to be about 0.00064 for the family of BSA peptides. The established averagine model for the BSA peptides could be used to optimize mass spectrometer settings for analyzing a compound of interest and/or to determine the Mₘₒₙₒ of the compound of interest, particularly when the compound of interest is known to be of or related to the class of BSA peptides or a derivative thereof.

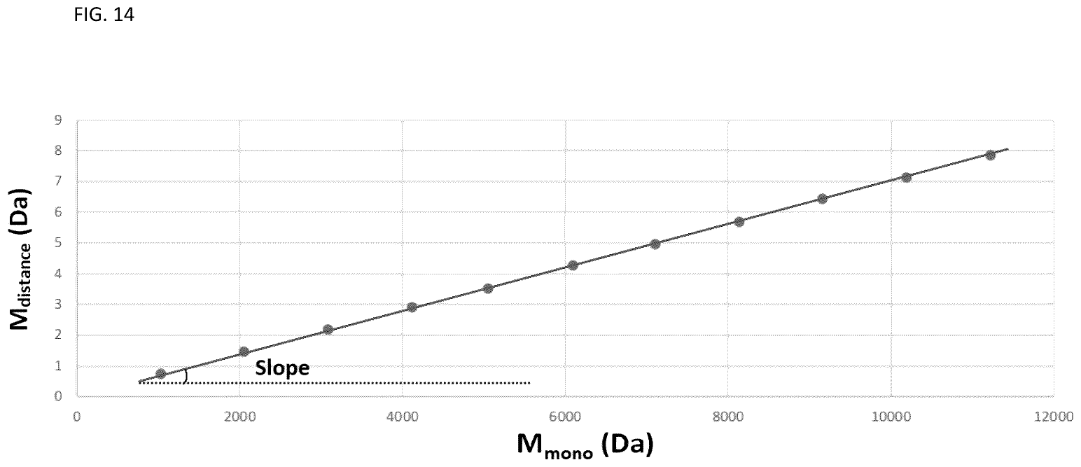

In another experiment, the validity of the assumption was further verified with a class of oligonucleotide, which has phosphorothioated locked nucleic acids and one unmodified DNA sequence. Table 1 below shows mass spectrometry test results of various known oligonucleotides. Using the averagine model, the M_{distance} and Mₘₒₙₒ form the mass spectrometry results were fit using a linear regression, and the fitting result is shown in FIG. 14. It was found that the M_{distance} is in a near perfect linear relationship with the Mₘₒₙₒ for the tested oligonucleotides, with the Slope calculated to be about 0.0007.

TABLE 1
Mass spectrometry results of various known compounds representing
phosphorothioated oligonucleotides.

| | | Monoisotopic | Base | Base m/z | | M_{distance} |
|---|---|---|---|---|---|---|
| Chemical formula | Mₘₒₙₒ (Da) | peak intensity | index | (Da) | Mₐᵥₑ (Da) | (Da) |
| C₃₀H₃₆N₁₁O₁₈P₃S₃ | 1027.061478 | 100 | 0 | 1027.061 | 1027.787 | 0.725522 |
| C₅₉H₇₂N₂₃O₃₆P₆S₆ | 2056.12603 | 100 | 0 | 2056.126 | 2057.569 | 1.44597 |
| C₈₉H₁₀₈N₃₄O₅₄P₉S₉ | 3083.187508 | 82.1 | 2 | 3085.189 | 3085.356 | 2.168492 |
| C₁₁₉H₁₄₅N₄₅O₇₂P₁₂S | 4111.256811 | 51.499 | 2 | 4113.269 | 4114.15 | 2.893189 |
| C₁₄₈H₁₈₁N₅₆O₈₉P₁₄S | 5047.377541 | 35.13 | 3 | 5050.381 | 5050.888 | 3.510459 |
| C₁₇₈H₂₁₇N₆₈O₁₀₇P₁₇ | 6088.442093 | 22.11 | 3 | 6091.446 | 6092.682 | 4.239907 |
| C₂₀₇H₂₅₃N₇₉O₁₂₅P₂₀ | 7103.50357 | 13.55 | 4 | 7105.508 | 7108.457 | 4.95343 |
| C₂₃₇H₂₈₉N₉₀O₁₄₃P₂₃ | 8130.565048 | 8.2 | 5 | 8135.57 | 8136.244 | 5.678952 |
| C₂₆₇H₃₂₅N₁₀₁O₁₆₁P₂ | 9157.626526 | 5.03 | 6 | 9163.632 | 9164.031 | 6.404474 |
| C₂₉₆H₃₆₁N₁₁₃O₁₇₉P₂ | 10186.69108 | 3.03 | 6 | 10192.7 | 10193.813 | 7.121922 |
| C₃₂₆H₃₉₇N₁₂₄O₁₉₇P₃ | 11213.75256 | 1.8 | 7 | 11220.76 | 11221.6 | 7.847444 |

It is noted that for the proteins and peptides, the unequal distribution of N, O, and S elements across the protein sequence was greater than the unequal distribution of elements in case of oligonucleotides. From the examples illustrated herein, it can be seen that the differences between the actual and estimated M_{distance} are within about 0.2 Da. In comparison, the respective differences for oligonucleotides were well within about 0.1 Da.

### Example 3—Assignment of Monoisotopic Mass Mₘₒₙₒ

To assign monoisotopic mass Mₘₒₙₒ to an isotope cluster of a mass spectrum for a given compound using the linear relationship of M_{distance} and Mₘₒₙₒ reflected in the established model, we first determined from the given neutral Mₐᵥₑ where Mₘₒₙₒ should be and then identify the closest monoisotopic (or isotope) peak. We further inspected the series for each charge state separately to assess whether any isotope cluster peak(s) for any charge state(s) is interfered. With this approach in cases of missing or low signal-to-noise (S/N) of one or more peaks at the start or the end of isotope cluster, we were able to assign the monoisotopic mass correctly with high accuracy.

In the TOF-MS data that covers a wide concentration range of analytes (or wide response with respect to different charge states), we first determined how much of the theoretical isotope pattern that have been detected (% intensity cutoff) to obtain the M_{distance}. In general, though, with considering the peaks >50% of base peak, the difference in the M_{distance} is 0.42 (at M=12000), which does not need any adjustments for the determination of correct monoisotopic mass.

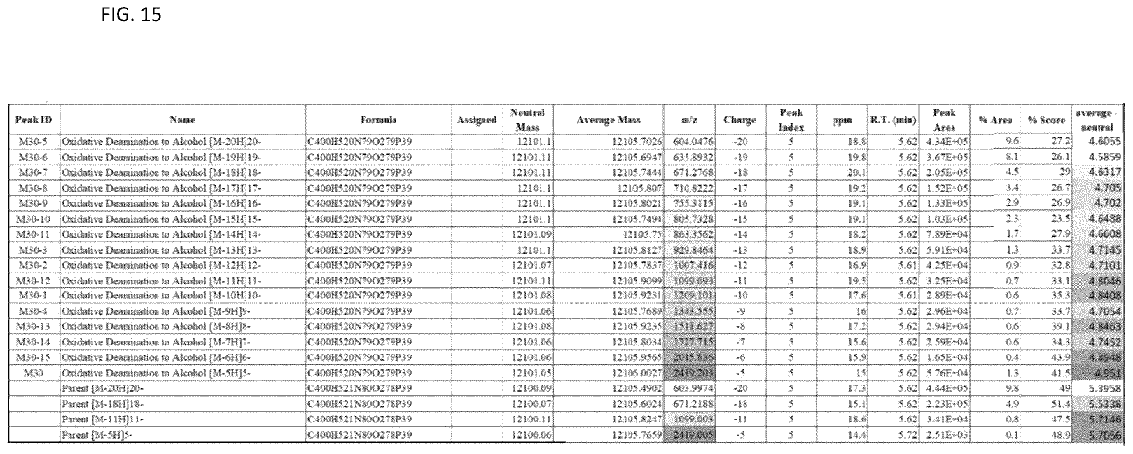

FIG. 15 shows the post-analysis results for 40dT oligomer and the assignment of monoisotopic mass (Mmono) to the isotopic peaks. The post-analysis using an existing MetabolitePilot program generated wrong monoisotopic mass assignment (as M−1 metabolite), because the MetabolitePilot program requires the monoisotopic peak be present in the spectral peak list and have the correct charge state. Within the processing of the example results, the monoisotopic spectral peak was detected, but its charge state could not be determined accurately.

Using the linear model of M_{distance} and Mₐᵥₑ according to the present disclosure, the correct monoisotopic mass for the compound could be deduced from the linear model. This could be used to filter or revise false positive assignments (e.g., oxidative deamidation M=1201) and report the correct ones (parent M=1200).

The present approach for monoisotopic mass determination could be also used to assess level of impurities that are not separated chromatographically and/or share a high degree of sequence analogy (e.g., deamidation, protein sequence analogues such as insulin variants). The approach would allow detection of multiply charged species that differ by less than 3 Da.

### Example 4—Assessing Hydrogen Deuterium (HD) Exchange Uptake

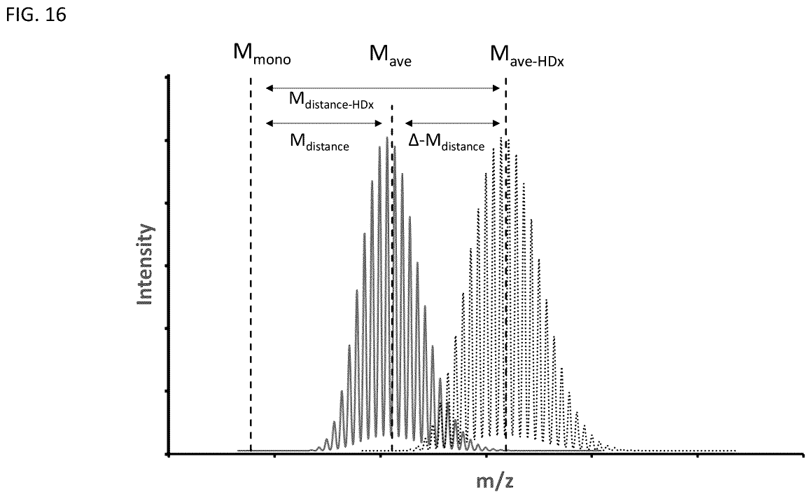

Hydrogen uptake experiments are used to gain knowledge on the 3D structure of biological compounds. These can be carried out directly in the solution phase or via gas phase exchange. In both of these approaches, the compound is exposed to deuterium (in liquid phase or as vapor), and exchangeable hydrogens, typically associated with specific functional groups, will be replaced by deuterium and will result in an increase in the mass of the analyte. The mass increase can be used to determine the number of accessible site, and therefore provide insight in the conformation of the compounds. FIG. 16 shows an example of a 17.18 kDa compound detected as +7 species. The solid trace shows the isotope distribution for the undeuterated form, along with its monoisotopic mass (Mₘₒₙₒ) and average mass (Mₐᵥₑ). The dashed trace shows the isotope distribution for the deuterated form of the compound. The average mass of the deuterated compound (M_{ave-HDX}) can be accurately determined using the methods according to the present disclosure. The determined M_{ave-HDX} may be further used to calculate the number of hydrogens that have undergone HD exchange, e.g., based on the mass difference between Mₐᵥₑ and M_{ave-HDX} (or Δ−M_{distance}). In the case presented here, an average of 15 deuteriums were incorporated in the compound through HD exchange. Note that the isotope distribution of the deuterated form is broader than that of the undeuterated form. Since there is a distribution of exchangeable site, the isotope envelope will be used to determine the average number of exchanged deuterium.

Although various embodiments and examples are described herein, those of ordinary skill in the art will understand that many modifications may be made thereto within the scope of the present disclosure. Accordingly, it is not intended that the scope of the disclosure in any way be limited by the examples provided.

1. A method for improving accuracy for determination of monoisotopic mass (Mₘₒₙₒ) of a compound of interest using a mass spectrometer, the method comprising:
adjusting instrument setting of the mass spectrometer using at least one known compound, wherein the instrument setting comprises at least one parameter;
analyzing the compound of interest using the adjusted instrument setting to obtain a mass spectrum thereof; and
determining the Mₘₒₙₒ of the compound of interest from the mass spectrum thereof.

2. The method of claim 1, wherein the method comprises determining the monoisotopic mass (Mₘₒₙₒ) of the compound of interest by:
adjusting the instrument setting, wherein the instrument setting comprises at least one parameter for improving accuracy;
wherein the mass spectrum comprises an isotope pattern of the compound of interest.

3. The method of claim 1, further comprising:
obtaining an average mass (Mₐᵥₑ) of the compound of interest based on the isotope pattern thereof, wherein the isotope pattern consists of a plurality of isotopic peaks representing an isotope distribution of ionized clusters derived from the compound of interest; and
determining the monoisotopic mass (Mₘₒₙₒ) of the compound of interest according to the following equation: Mₘₒₙₒ=Mₐᵥₑ/(1+Slope), wherein Slope has a predetermined value.

4. The method of claim 1, wherein the adjusting instrument setting of the mass spectrometer comprises:
analyzing the known compound using the mass spectrometer to produce a mass spectrum thereof, wherein the known compound has a predetermined Mₘₒₙₒ, and wherein the mass spectrum comprises one or more m/z isotope pattern thereof;
obtaining an experimental Mₐᵥₑ of the known compound based on the m/z isotope pattern of the known compound and a given charge state z for each m/z isotope pattern;
tuning the at least one parameter of the mass spectrometer when analyzing the known compound and monitoring one or more m/z isotope patterns thereof in response to the parameter change;
determining an optimal level/range of the parameter under which the experimental Mₐᵥₑ for each charge state of the known compound correlate to a predetermined theoretical value; and
recording/saving the adjusted instrument setting.

5. The method of claim 1, wherein the adjusting instrument setting of the mass spectrometer comprises:
analyzing a sample containing a mixture of known compounds, each known compound having a predetermined Mₘₒₙₒ, and wherein the mass spectrum comprises one or more m/z isotope pattern thereof related to each known compound;
obtaining an experimental Mₐᵥₑ of each known compound based on m/z isotope patterns related to each known compound and a given charge state z for each m/z isotope pattern;
tuning the at least one parameter of the mass spectrometer when analyzing the known compound and monitoring one or more m/z isotope patterns thereof in response to the parameter change;
determining an optimal level/range of the parameter under which the experimental Mₐᵥₑ for each charge state of each known compound correlate to a predetermined theoretical value with respect to each known compound; and
recording/saving the adjusted instrument setting.

6. The method of claim 5, wherein the predetermined Mₘₒₙₒ for the known compounds differ from each other and cover a mass range.

7. The method of claim 4, wherein the predetermined theoretical value of Mₐᵥₑ is determined according to the one or both of the following models or any equivalent thereof:
$${M}_{ave} = {M}_{mono} ⋆ ( 1 + Slope ) , \qquad ( I )$$
$${M}_{ave} = {M}_{mono} + {M}_{distance} , \qquad ( II )$$
wherein Slope has a predetermined value and M_{distance}=Mₘₒₙₒ*Slope.

8. The method of claim 3, wherein the value of Slope is determined by:
analyzing a plurality of standard compounds by using the mass spectrometer to obtain an experimental Mₐᵥₑ of each standard compound, wherein experimental values of the Mₐᵥₑ are distributed in an operational range, and wherein each of the standard compound has a theoretical Mₘₒₙₒ;
obtaining an experimental value of M_{distance} for each of the standard compound according to equation: M_{distance}=Mₐᵥₑ−Mₘₒₙₒ;
fitting the experimental values of the M_{distance} and the theoretical Mₘₒₙₒ using a linear model in the operational range to deduce the following equation or an equivalent thereof: Slope=M_{distance}/Mₘₒₙₒ; and
determining the value of Slope.

9. The method of claim 4, wherein the experimental Mₐᵥₑ of the known compound is calculated by averaging the peak mass of the isotopic peaks using a peak intensity cutoff of about 0.1, or about 0.2, or about 0.3, or about 0.4, or about 0.5.

10. The method of claim 1, wherein the compound of interest and the known compound are of the same chemical or biochemical class.

11. The method of claim 1, wherein the compound of interest and the known compound both belong to a class of biomacromolecule selected from peptide, protein, nucleotide, polycarbohydrate, or derivatives/metabolites thereof.

12. The method of claim 1, further comprising obtaining an estimated range of molecular mass of the compound of interest prior to adjusting instrument setting.

13. The method of claim 11, wherein the known compound has a Mₘₒₙₒ that is in the estimated range of molecular mass (M) of the compound of interest.

14. The method of claim 12, wherein the estimated range is from about 100 Da to about 100 Da to about 100 kDa, or from about 500 Da to about 80 kDa, or from about 1 kDa to about 60 kDa, or from about 5 kDa to about 50 kDa, or from about 10 kDa to about 40 kDa, or of at least 100 Da, or at least 500 Da, or at least 1 kDa, or at least 5 kDa, or at least 10 kDa, or at least 20 kDa, or at least 40 kDa.

15. The method of claim 8, wherein the standard compound and the compound of interest are of the same chemical or biochemical class.

16. A method for determining monoisotopic mass (Mₘₒₙₒ) of a compound of interest using a mass spectrometer, the method comprising:
adjusting/verifying instrument setting of the mass spectrometer by:
analyzing at least one known compound using the mass spectrometer to produce a mass spectrum thereof, wherein the known compound has a predetermined Mₘₒₙₒ, and wherein the mass spectrum comprises a series of m/z isotope patterns thereof;
obtaining an experimental Mₐᵥₑ of the known compound based on the measured series of m/z isotope patterns of the known compound;
tuning the at least one parameter of the mass spectrometer when analyzing the known compound and monitoring the members of m/z isotope pattern series thereof in response to the parameter change;
determining an optimal level/range of the parameter under which the experimental Mₐᵥₑ of the known compound correlates to the predetermined Mₘₒₙₒ at each charge state;
recording/saving the filtering instrument setting;
analyzing the compound of interest using the filtering instrument setting to obtain a mass spectrum thereof, wherein the mass spectrum comprises an isotope pattern thereof;
obtaining an average mass (Mₐᵥₑ) of the compound of interest based on the series of m/z isotope patterns thereof; and establishing a linear model based on the elemental composition of the class or type compound representative or a detailed information of the compound of interest according to the following equations:
$${M}_{distance} = {M}_{ave} - {M}_{mono} ,$$
M_{distance}=Slope*Mₘₒₙₒ, wherein Slope has a predetermined value; and
determining the Mₘₒₙₒ of the compound of interest according to the following equation:
$${M}_{mono} = {M}_{ave} / ( 1 + Slope ) .$$

17. A system for determining monoisotopic mass (Mₘₒₙₒ) of a compound of interest in a sample, the system comprising:
a mass spectrometer comprising:
an ion generator configured to ionize a compound and produce an isotopic ion cluster thereof; and
an analyzer configured to analyze the ion cluster and obtain m, z, and m/z of the ion cluster, and
a computer system in communication with the mass spectrometer, wherein the computer system is configured to:
tune in response to a user instruction, at least one parameter of the mass spectrometer;
instruct the mass spectrometer to analyze the compound of interest under a filtering instrument setting determined by at least one known compound;
receive the series of signal for series of m/z of the ion clusters and produce a mass spectrum of the compound of interest;
calculate a Mₐᵥₑ for each charge series of the compound based on the mass spectrum thereof; and
determine the Mₘₒₙₒ for each individual charge state of the compound of interest according the following equation: Mₘₒₙₒ=Mₐᵥₑ/(1+Slope), wherein Slope has a predetermined value.
consolidate the results from each individual charge state into Mₘₒₙₒ for the compound of interest.

18. The system of claim 17, wherein the system is further configured to:
analyze the known compound to produce a mass spectrum thereof, wherein the known compound has a predetermined Mₘₒₙₒ, and wherein the mass spectrum comprises at least one isotope pattern thereof;
obtain an experimental Mₐᵥₑ of the known compound based on the isotope pattern of the known compound;
tune the at least one parameter of the mass spectrometer when analyzing the known compound and monitoring the isotope pattern thereof in response to the parameter change;
determine an optimal level/range of the parameter under which the experimental Mₐᵥₑ of the known compound correlates to the predetermined Mₘₒₙₒ according to the following equations of any equivalent thereof:
$${M}_{mono} = {M}_{ave} / ( 1 + Slope ) ,$$
Mₘₒₙₒ=Mₐᵥₑ−M_{distance}, wherein Slope has a predetermined value and M_{distance}=Mₘₒₙₒ*Slope; and
record/save the adjusted instrument setting.

19. A computer-readable medium containing computer instructions stored therein, wherein computer-readable medium is configured to cause a computer to perform the method of claim 18.

20. The computer-readable medium of claim 19, wherein the value of Slope is determined by:
analyzing a plurality of standard compounds by using the mass spectrometer to obtain an experimental Mₐᵥₑ of each standard compound, wherein experimental values of the Mₐᵥₑ are distributed in an operational range, and wherein each of the standard compound has a theoretical Mₘₒₙₒ;
obtaining an experimental value of M_{distance} for each of the standard compound according to equation: M_{distance}=Mₐᵥₑ−Mₘₒₙₒ;
fitting the experimental values of the M_{distance} and the theoretical Mₘₒₙₒ using a linear model in the operational range to deduce the following equation or an equivalent thereof: Slope=M_{distance}/Mₘₒₙₒ; and
determining the value of Slope.
